(19) United States
(12) Patent Application Publication
(10) Pub. No.: US 2013/0312609 A1
(43) Pub. Date: Nov. 28, 2013

(54) APPARATUS AND METHODS FOR FILTRATION OF SOLID PARTICLES AND SEPARATION OF LIQUID DROPLETS AND LIQUID AEROSOLS FROM A GAS STREAM

(71) Applicant: Michel van Vorselen, Midview City (SG)

(72) Inventor: Michel van Vorselen, Midview City (SG)

(73) Assignee: KRANJI SOLUTIONS PTE LTD, Midview City (SG)

(21) Appl. No.: 13/884,858

(22) PCT Filed: Nov. 12, 2010
(86) PCT No.: PCT/SG2010/000428

§ 371 Date: Jul. 1, 2013

(51) Int. Cl. B01D 50/00

(52) U.S. Cl. CPC B01D 50/002
USPC 95/268; 55/337

(57) ABSTRACT

An apparatus for filtration of solid particles and separation of liquid droplets and liquid aerosols from a gas stream for installation in a vessel comprises a cyclonic separator for coarse separation of solid particles and separation of liquid droplets and liquid aerosols from the gas stream. The cyclonic separator has one or more slots or perforations. A filter element for fine filtration from the gas stream has an inlet for receipt of the gas stream directly from a gas outlet of the cyclonic separator. A shroud partitions the one or more slots or perforations from a dry gas volume of the vessel.

### BACKGROUND

In the oil and gas upstream and downstream industry, mixtures of gas and liquids and solid particles often require further treatment. The fluids, gas and solid particles, need to be separated in separate streams for processing or transportation. The separation is done in several stages. Separation can be achieved by gravity, centrifugal forces, or by inertia. Once the bulk separation has taken place, the fine separation and filtration of the gas will take place in scrubbers or separators further downstream. Poor separation and filtration can considerably impair the production figures of oil and gas fields.

The fine separation and filtration is often performed by coalescing filter elements. Conventionally, as illustrated in FIG. 2, the coalescing filter elements 6, 7, supported on a standpipe 12, will filter the solid particles and separate the liquid droplets and liquid aerosols from the gas stream.

When the amount of liquid droplets or solid particles is too much for the coalescing filter element to handle, an upstream pre-separator is used to offload the coalescing filter. Conventionally this separate pre-separator is installed in an upstream vessel, or in the same vessel detached from and upstream of the coalescing filter elements and its supporting standpipe.

U.S. Pat. No. 4,759,782 discloses a coalescing filter which purports to be capable of removing liquid aerosols (such as water and oil) from gaseous streams with high efficiency. The filter comprises three layers, (a) an intermediate fibrous layer having a pore size of from about 1.25(t) to about 2(t), where t is the dynamic film thickness of the aerosol in the gaseous stream, the fibers of the intermediate fibrous layer having diameters ranging from about 0.1 to about 20 micrometers, (b) a fibrous layer upstream of the intermediate layer having a pore size greater than the intermediate layer, and (c) a downstream fibrous layer having a pore size greater than the intermediate layer and wherein the critical surface energy of each layer of the filter is less than the surface tension of the liquid making up the aerosol.

United States Patent Publication No. 2005/0000200 A1 discloses an axial flow demisting cyclone for separation of a mixture of gas and liquid including an inlet for gas containing liquid droplets and an outlet for substantially dry gas, including a mainly cylindrical cyclone tube with at least one path of slots or perforations allowing a part of the fluid, including separated liquid, to flow out of the cyclone tube. The demisting cyclone also includes a swirl inducing device to set the entering fluid in rotation. This swirl-inducing device is formed from a cascade of vanes attached to a concentric core body, preferably cylindrical in shape, which extends towards the wall of the cyclone tube, the vanes being in the longitudinal direction of the vanes from their leading edge to their trailing edge.

DE4000845 discloses a gas/liquid mixture for separation tangentially entering an outer the outer chamber of a first cyclone separator horizontally mounted in a preliminary separation chamber of a horizontal drum. This cyclone terminates at an intermediate partition beyond which is a separation chamber for fine residual liquid droplets, operating with a porous cylindrical filter. Both areas in the first cyclone are defined by cylinder walls whereof the inner wall forms a gas-only connection between the two chambers. This document purports to offer techniques which improve liquid separation efficiency in the first separator chamber.

### SUMMARY

The invention is defined in the independent claims. Some optional features of the invention are defined in the dependent claims.

Implementation of the techniques disclosed herein may provide several significant benefits. For instance, where the cyclonic separator and the filter element are provided within a vessel, where a shroud partitions the one or more slots or perforations in the cyclonic separator from a dry gas volume of the vessel, this leads to a very compact and cost-effective, yet highly efficient filtration and separation device, able to cope with high concentrations of liquid droplets, liquid aerosols and or high concentrations of solid particles.

Compared to a single cyclonic separator the described device provides substantially higher removal efficiencies of liquid droplets, liquid aerosols and solid particles from a gas flow.

Implementation of the techniques disclosed herein are particularly advantageous when the filter element is a coalescing filter element. Compared with a single coalescing filter element the described device can handle substantially higher concentrations of liquid droplets and liquid aerosols. Due to the cyclonic separator, the size of liquid droplets, the number of liquid droplets and liquid aerosols in the gas stream will be reduced drastically before the gas reaches the coalescing filter element. This “offloading effect” leads to:
an improved efficiency of the coalescing filter element
a considerable lower pressure drop over the coalescing filter element, which can lead to a lower overall pressure drop.
a larger allowable gas flow rate per coalescing filter element.

Due to the increased allowable gas flow rate per coalescing filter element, a reduced number of coalescing filter elements will be required to handle a given gas flow rate, hence a reduction in vessel diameter can be achieved.

Implementation of the techniques disclosed herein may lead to an overall vessel height reduction. In at least one implementation, the standpipe of a filter element is replaced by a cyclonic separator or integrated with the cyclonic separator, providing a considerable height reduction compared to conventional designs where a pre-separator unit is detached from and upstream of the coalescing filter element.

Implementation of the techniques disclosed herein may lead to considerable saving on materials and weight compared to the conventional designs where a pre-separator unit is detached from and upstream of the coalescing filter element.

The devices as disclosed herein may also be used in existing vessels for retrofit situations. In case higher throughputs (in liquid flow, as well as gas flow) are required or if an existing coalescing filter vessel is malperforming (due to too high concentrations of liquids) the device can be easily installed in the existing vessel by integrating the cyclone separator into, say, the standpipe of the (coalescing) filter element, or replacing the standpipe with the cyclonic separator and shroud. In many of these retrofit applications there will not be adequate space for a pre-separator that is detached from and upstream of a coalescing filter element supported by a standpipe, in the same vessel.

### BRIEF DESCRIPTION OF DRAWINGS

The invention will now be described, by way of example only, and with reference to the accompanying drawings in which:

FIG. 1 is an elevational view of a first apparatus for filtration of solid particles and separation of liquid droplets and liquid aerosols from a gas stream;

FIG. 2 illustrates a conventional design of a coalescing filter element positioned on a standpipe

FIG. 3 is an elevational view of a second apparatus for filtration of solid particles and separation of liquid droplets and liquid aerosols from a gas stream;

FIG. 4 is an elevational view of a third apparatus for filtration of solid particles and separation of liquid droplets and liquid aerosols from a gas stream;

FIG. 5 is an elevational view of a fourth apparatus for filtration of solid particles and separation of liquid droplets and liquid aerosols from a gas stream;

FIG. 6 is an elevational view of a fifth apparatus for filtration of solid particles and separation of liquid droplets and liquid aerosols from a gas stream;

FIG. 7 is an elevational view of a sixth apparatus for filtration of solid particles and separation of liquid droplets and liquid aerosols from a gas stream;

FIG. 8 is an elevational view of a seventh apparatus for filtration of solid particles and separation of liquid droplets and liquid aerosols from a gas stream; and

FIG. 9 is an elevational view of an eighth apparatus for filtration of solid particles and separation of liquid droplets and liquid aerosols from a gas stream.

### DETAILED DESCRIPTION

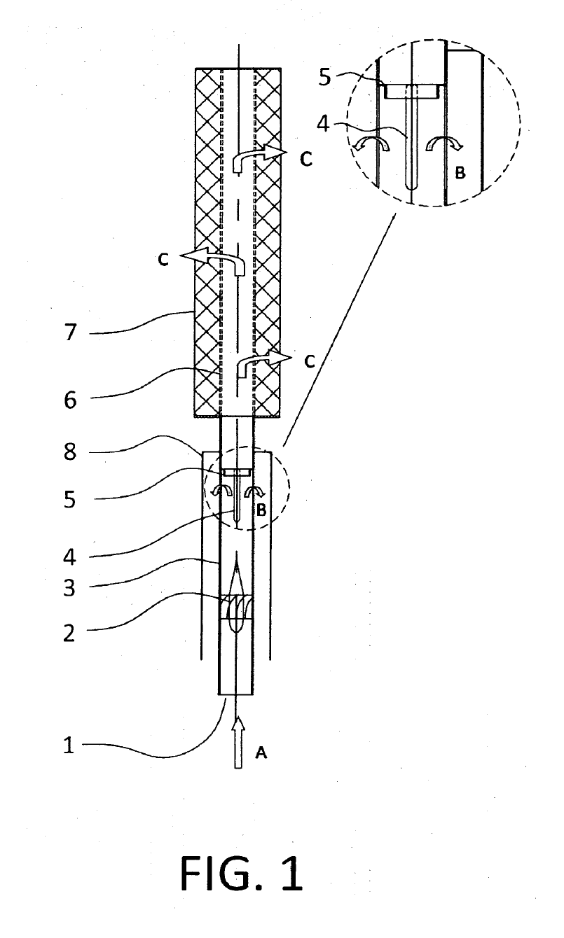

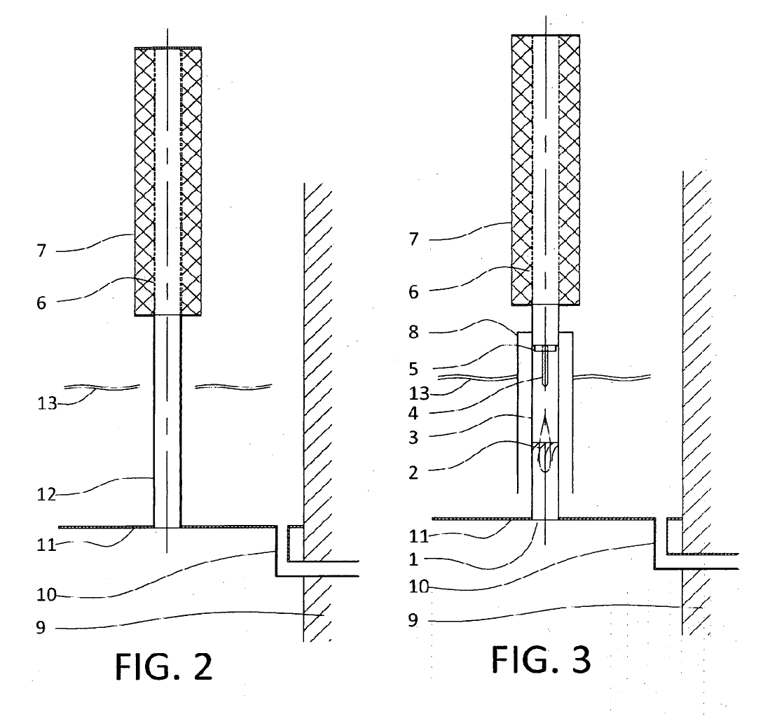

Turning first to FIG. 1, a first apparatus for filtration of solid particles and separation of liquid droplets and liquid aerosols from a gas stream is illustrated. The apparatus comprises an inlet 1 for the gas stream A. The device also comprises a cyclonic separator which, in the example of FIG. 1, comprises: a swirl inducing device 2 for setting the fluids in the gas stream in rotation about an axis of the device; a cylindrical tube 3 with one or more slots or perforations 4 where separated liquids and solids will be purged out of the cyclone separator; a circular lip 5; a filter element which, in the example of FIG. 1, is a coalescing filter element, comprising of a perforated support core 6 surrounded by coalescing filter media 7; and a shroud 8 for preventing gas to bypass the coalescing filter element and therefore partitioning the one or more slots or perforations of the cyclonic separator from the dry gas outlet of the coalescing filter element (flow C).

In essence, FIG. 1 illustrates apparatus for filtration of solid particles and separation of liquid droplets and liquid aerosols from a gas stream A, the apparatus being for installation in a vessel (not shown) and comprising: a cyclonic separator 2, 3 for coarse filtration of solid particles and separation of liquid droplets and liquid aerosols from the gas stream, the cyclonic separator having one or more slots or perforations 4. The apparatus also comprises a filter element 6, 7 for fine filtration of solid particles and separation of liquid droplets and liquid aerosols from the gas stream. An inlet of the filter element is arranged for receipt of the gas stream directly from a gas outlet of the cyclonic separator. A shroud 8 partitions the one or more slots or perforations 4 from a dry gas volume (not shown) of the vessel.

In the example of FIG. 1, filter element 6, 7 is a coalescing filter element as will be understood by a skilled person. However, in an alternative arrangement, filter element 6, 7 is a simple filter element, not having any particular properties specifically designed to provide a coalescing function. During filtration, solid particles are removed from the fluid stream by the filter medium. During coalescence, small droplets are merged into larger ones as they pass through several layers of filter media in the coalescer. These larger droplets are separated from the gas stream by gravity.

In terms of performance, some filter/coalescer elements are capable of droplet capture of less than 0.1 micron and solid particle capture of 0.3 micron. A cyclone separator is capable of droplet and solid particle capture in the range of 5-10 micron.

Provision of the shroud means that any gas which escapes through the one or more slots or perforations 4 cannot bypass the (coalescing) filter element; any gas from the gas stream of which most of the liquid droplets and solid particles have been separated by the cyclonic separator 2, 3 then passes to the downstream filter element 6, 7, where the gas which has been further separated from liquid droplets and solid particles, exits the filter element as illustrated by Flow C in FIG. 1 to the vessel internal volume. Thus, this volume of the vessel is considered to be a dry gas volume of the vessel. Further, shroud 8 also serves to partition the one or more slots or perforations 4 of the cyclonic separator 2, 3 from the dry gas outlet of the coalescing filter element.

As mentioned above, the shroud operates to partition the one or more slots or perforation in the cyclonic separator from the dry gas volume of the vessel. In the example of FIG. 1, the shroud 8 comprises of an external surface arranged to surround the cyclonic separator at least partially. In this example, the external surface of the shroud surrounds the one or more slots or perforations 4. In the example of FIG. 1, shroud 8 has a substantially cylindrical cross-sectional shape in order to be arranged in a concentric fashion around cylindrical tube 3 of the cyclonic separator. In alternative arrangements, the shroud may have a rectangular or other cross-sectional area. The substantially cylindrical shroud 8 has a top surface arranged for fixing around the standpipe of the filter/coalescer element or the cyclonic separator when there is no standpipe. Shroud 8 has an opening at the bottom as viewed in FIG. 1, the reason for which will become apparent from the discussion of FIG. 3. In the example of FIG. 1, the shroud has an external surface formed of a solid material. In an alternative arrangement, the shroud may have an external surface formed of a porous material, discussed in further detail below.

An important feature of the apparatus of FIG. 1 is that a gas outlet of the cyclonic separator discharges directly to an inlet of the coalescing filter element. What this means is that there are no other devices intermediate the cyclonic separator and the coalescing filter element. In one arrangement the outlet of the cyclonic separator abuts the inlet of the coalescing filter element. In another arrangement a section of pipe/conduit is disposed between the cyclonic separator and the coalescing filter element, for flow of the gas stream “directly” from the cyclonic separator to the coalescing filter element. However, in essence, the floor of the gas stream is directly from the cyclonic separator to the coalescing filter element, in the absence of an intermediate device.

The cyclonic separator comprises a swirl inducing device 2 that set the fluids in the gas stream in rotation, a cylindrical tube 3 in which the one or more slots or perforations 4 are provided. As mentioned, separated liquids and solids will be purged out of the cyclone separator through the one or more slots or perforations 4. The fluid flow (Flow A) will enter the cyclone separator axially at the inlet 1. Alternatively the fluid flow can enter the cyclone separator tangentially. With this tangential design, one or a number of inlets will be positioned tangentially on the cyclone separator so that fluid in the gas stream entering the cylindrical tube 3 enter into the curved inner surface of a cylindrical tube 3 forming a “swirling” motion around the axis of a cylindrical tube 3.

For the described device with the axial inlet 1 a swirl inducing device 2 will create a swirling flow pattern inside the cyclone separator. The swirl inducing device 2 consists out of a hub with curved swirling blades. These blades force the fluids into a rotation, whereby the heavier parts (liquid droplets, liquid aerosols and solid particles) form a liquid film with solid particles on the inner surface of the cylindrical cyclone tube 3.

This liquid film with solid particles will be purged out of the cyclone separator via the one or more slots or perforations 4, as illustrated with the arrows showing flow B. A circular lip 5 will prevent the remaining film (if any) which forms on the inner surface of cylindrical cyclone tube 3 from travelling further to the outlet of the cyclone separator 3 to an inlet of the coalescing filter element.

After passing through the cyclonic separator 2, 3 gas in the gas stream can be considered to be “nearly dry” in that a significant number of liquid droplets and liquid aerosols will already have been separated by the course location of the cyclonic separator. The nearly dry and cleaned gas will reach the coalescing filter element, which, in the example of FIG. 1, comprises of a perforated support core 6 surrounded by coalescing filter media 7. Within the coalescing media, further liquid droplets, liquid aerosols and solid particles are filtered, coalesced and separated from the gas stream. This dry and clean gas flows into the dry gas volume of the vessel as represented by the arrows illustrating flow C.

The shroud 8 prevents gas from bypassing the coalescing filter element and partitions the one or more slots or perforations of the cyclonic separator from the dry gas outlet of the coalescing filter element, and the dry gas volume of the vessel. For the shroud design there are several options.

The shroud 8 can have a shroud opening submerged below the liquid level 13, hence preventing gas to bypass the coalescing filter element. This design is shown in FIG. 3. In this example, the liquid which has been separated from the gas stream acts in concert with shroud 8 to partition the one or more slots or perforations of the cyclonic separator 3 from the dry gas volume of the vessel.

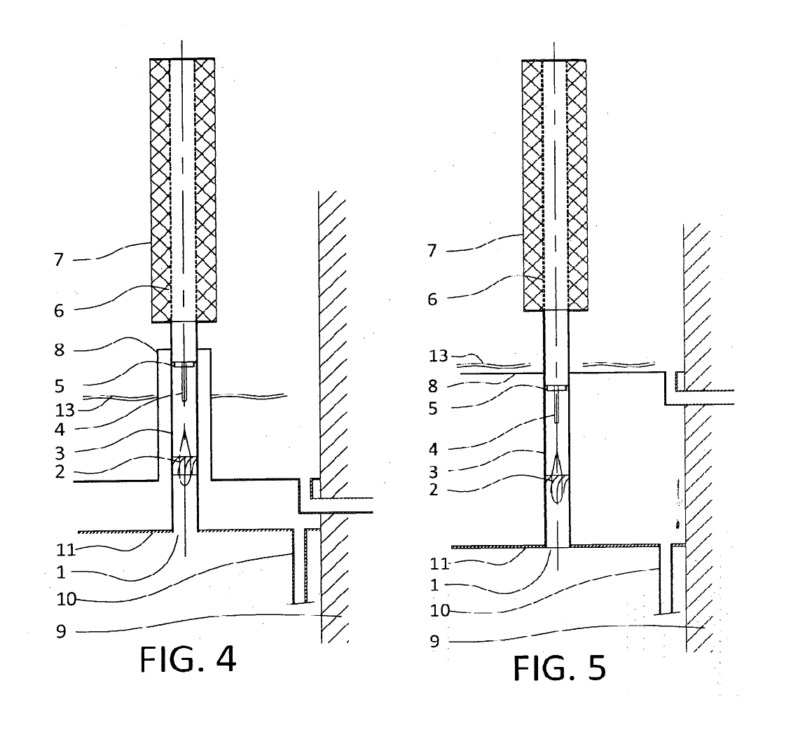

The shroud 8 can create an internal vessel volume partitioned from the dry gas outlet of the coalescing filter element. The shroud is consisting out of a vertical part surrounding part of the cyclone separator and a horizontal part extended to the vessel wall 9. Thus, the shroud is arranged for installation within the vessel to define an internal volume of the shroud partitioned from the dry gas volume of the vessel. In this example, the shroud operates together with the vessel wall to define the internal volume of the shroud. The internal volume contains a drain 10 to drain the separated liquids and solids from the cyclone separator. This design is shown on FIG. 4.

The shroud 8 can create an internal vessel volume partitioned from the dry gas outlet of the coalescing filter element. The shroud is consisting out of a horizontal part extended to the vessel wall 9. The internal volume contains a drain 10 to drain the separated liquids and solids from the cyclone separator. This design is shown on FIG. 5.

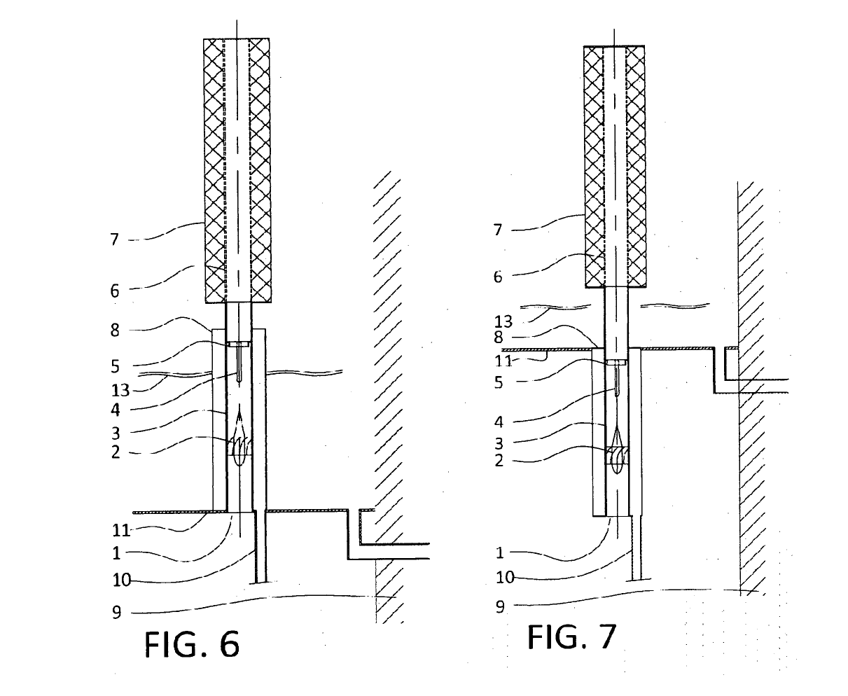

The shroud 8 can create an internal volume partitioned from the dry gas outlet of the coalescing filter element. The internal volume compartment contains a drain 10 to drain the separated liquids and solids from the cyclone separator. The shroud containing the internal volume is installed on top of a support plate 11. This design is shown on FIG. 6. The shroud containing the internal volume can contain the gas and separated liquids and solids from one or a plurality of cyclone separators.

The shroud 8 can create an internal volume partitioned from the dry gas outlet of the coalescing filter element. The internal volume compartment contains a drain 10 to drain the separated liquids and solids from the cyclone separator. The shroud containing the internal volume is installed below a support plate 11. This design is shown on FIG. 7. The support plate can also support anywhere between the bottom and the top of the shroud. The shroud containing the internal volume can contain the gas and separated liquids and solids from one or a plurality of cyclone separators.

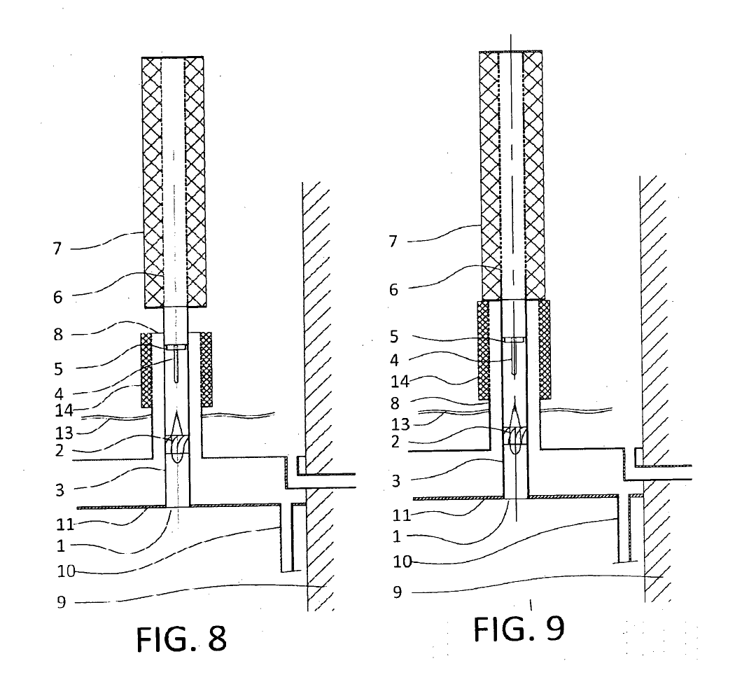

As noted above, the shroud 8 may comprise of an external surface formed of a porous material 14. This porous material could be filter media, or coalescing filter media. Gas that may exit the cyclone separator via the one or more slots or perforations 4 will be treated by this coalescing filter media. Solid particles will be filtered and liquid droplets and aerosols will be coalesced and separated. This coalescing filter media requires a higher inertial resistance compared to the top coalescing filter element in order to minimise the amount of gas exiting the cyclone separator via one or more slots or perforations. This porous material could be extended up to the coalescing filter element. These designs are shown on FIG. 8 and FIG. 9. When the shroud comprises of such a porous material, it will still partition the one or more slots or perforations from the dry gas volume of the vessel to a certain degree.

One or a plurality of these apparatus can be installed to a support plate 11 in a vessel. The drains 10 draining the separated liquids and solids of the cyclone separator and separated liquids from the coalescing filter element can run to the bottom of the vessel or can leave the vessel via a side outlet nozzle.

In all of the examples above, the cyclonic separator and the filter element are disposed in a vertical or substantially vertical orientation. Other arrangements, although not illustrated, are contemplated. For instance, it may be that only one of the cyclonic separator and the filter element is disposed in the vertical or substantially vertical orientation. Alternatively, it may be that at least one of the cyclonic separator and the filter element are disposed in a horizontal or substantially horizontal orientation. When installed horizontally or substantially horizontally it is preferred for the shroud 8 to create an internal volume partitioned from the dry gas outlet of the coalescing filter element, preventing gas to bypass the coalescing filter element.

The coalescing filter element is removable and can be easily replaced by spare coalescing filter elements.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. An apparatus for filtration of solid particles and separation of liquid droplets and liquid aerosols from a gas stream, the apparatus being for installation in a vessel and comprising:
a cyclonic separator for coarse filtration of solid particles and separation of liquid droplets and liquid aerosols from the gas stream, the cyclonic separator having one or more slots or perforations;
a filter element for fine filtration of solid particles and separation of liquid droplets and liquid aerosols from the gas stream, an inlet of the filter element being for receipt of the gas stream discharged directly from a gas outlet of the cyclonic separator; and
a shroud for partitioning the one or more slots or perforations from a dry gas volume of the vessel.

2. The apparatus of claim 1, wherein the apparatus is an axial flow device, flow of gas through the apparatus being along an axis of the device, from the cyclonic separator to the filter element.

3. The apparatus of claim 1, wherein the filter element is a coalescing filter element.

4. The apparatus of claim 1, wherein the shroud has a shroud opening for submersion below a liquid level.

5. The apparatus of claim 1, wherein the shroud is arranged for installation within the vessel to define an internal volume of the shroud partitioned from the dry gas volume of the vessel.

6. The apparatus of claim 5, wherein the shroud comprises a drain for draining of liquid having been separated from the gas stream by the cyclonic separator.

7. The apparatus of claim 1, wherein at least one of the cyclonic separator and the filter element are disposed in a horizontal or substantially horizontal orientation.

8. The apparatus of claim 1, wherein at least one of the cyclonic separator and the filter element are disposed in a vertical or substantially vertical orientation.

9. The apparatus of claim 1, wherein the shroud comprises an external surface formed of a solid material.

10. The apparatus of claim 1, wherein the shroud comprises an external surface formed of a porous material.

11. A vessel for filtration of solid particles and separation of liquid droplets and liquid aerosols from a gas stream, the vessel having a separation apparatus installed therein, the separation apparatus comprising:
a cyclonic separator for coarse filtration of solid particles and separation of liquid droplets and liquid aerosols from the gas stream, the cyclonic separator having one or more slots or perforations;
a filter element for fine filtration of solid particles and separation of liquid droplets and liquid aerosols from the gas stream, an inlet of the filter element being arranged to receive the gas stream discharged directly from a gas outlet of the cyclonic separator; and
a shroud for partitioning the one or more slots or perforations from a dry gas volume of the vessel.

12. A method of filtering solid particles and separating liquid droplets and liquid aerosols from a gas stream in a vessel, the method comprising:
effecting coarse filtration of solid particles and separation of liquid droplets and liquid aerosols from the gas stream, using a cyclonic separator having one or more slots or perforations;
effecting fine filtration of solid particles and separation of liquid droplets and liquid aerosols from the gas stream using a filter element, an inlet of the filter element receiving the gas stream discharged directly from a gas outlet of the cyclonic separator; and
partitioning the one or more slots or perforations from a dry gas volume of the vessel with a shroud.
